(19) United States
(12) Patent Application Publication
(10) Pub. No.: US 2024/0107472 A1
(43) Pub. Date: Mar. 28, 2024

(54) INTER-SATELLITE MOBILITY

(71) Applicant: QUALCOMM Incorporated, San Diego, CA (US)

(72) Inventors: Bharat SHRESTHA, San Diego, CA (US); Xiao Feng WANG, San Diego, CA (US); Jae Ho RYU, San Diego, CA (US); Liangping MA, San Diego, CA (US); Alberto RICO ALVARINO, San Diego, CA (US); Umesh PHUYAL, San Diego, CA (US); Changhwan PARK, San Diego, CA (US); Ayan SENGUPTA, San Diego, CA (US); Peter GAAL, San Diego, CA (US)

(21) Appl. No.: 18/335,660

(22) Filed: Jun. 15, 2023

Related U.S. Application Data
(60) Provisional application No. 63/377,464, filed on Sep. 28, 2022.

(51) Int. Cl. H04W 56/00

(52) U.S. Cl. CPC H04W 56/0015; H04W 84/06

(57) ABSTRACT

Various aspects of the present disclosure generally relate to wireless communication. In some aspects, a user equipment (UE) may receiving information identifying a timing and position for a transition from a first synchronization signal block associated with a first cell to a second synchronization signal block associated with a second cell, wherein the first cell and the second cell have a common physical cell index and a common frequency. The UE may tune from the first synchronization signal block to the second synchronization signal block in accordance with the timing and position. Numerous other aspects are described.

### CROSS-REFERENCE TO RELATED APPLICATION

This Patent Application claims priority to U.S. Provisional Patent Application No. 63/377,464, filed on Sep. 28, 2022, entitled “INTER-SATELLITE MOBILITY,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for inter-satellite mobility.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include a memory and one or more processors coupled to the memory. The one or more processors may be configured to receive information identifying a timing and position for a transition from a first synchronization signal block associated with a first cell to a second synchronization signal block associated with a second cell. The one or more processors may be configured to tune from the first synchronization signal block to the second synchronization signal block in accordance with the timing and position.

Some aspects described herein relate to a method of wireless communication performed by a UE. The method may include receiving information identifying a timing and position for a transition from a first synchronization signal block associated with a first cell to a second synchronization signal block associated with a second cell, where the first cell and the second cell have a common physical cell index and a common frequency. The method may include tuning from the first synchronization signal block to the second synchronization signal block in accordance with the timing and position.

Some aspects described herein relate to a non-transitory computer-readable medium that stores a set of instructions for wireless communication by a UE. The set of instructions, when executed by one or more processors of the UE, may cause the UE to receive information identifying a timing and position for a transition from a first synchronization signal block associated with a first cell to a second synchronization signal block associated with a second cell. The set of instructions, when executed by one or more processors of the UE, may cause the UE to tune from the first synchronization signal block to the second synchronization signal block in accordance with the timing and position.

Some aspects described herein relate to an apparatus for wireless communication. The apparatus may include means for receiving information identifying a timing and position for a transition from a first synchronization signal block associated with a first cell to a second synchronization signal block associated with a second cell, where the first cell and the second cell have a common physical cell index and a common frequency. The apparatus may include means for tuning from the first synchronization signal block to the second synchronization signal block in accordance with the timing and position.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a regenerative satellite deployment and an example of a transparent satellite deployment in a non-terrestrial network.

FIG. 5 is a diagram illustrating an example 500 of a handover in a non-terrestrial network.

FIGS. 6A-6E are diagrams illustrating an example 600 of inter-satellite mobility.

FIG. 7 is a diagram illustrating an example process performed, for example, by a UE, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

In a fixed cell scenario, a first cell, from a first satellite, may remain fixed at a particular area for a particular duration. After the particular duration has elapsed, the first cell may be switched off and a second cell, from a second satellite, may be switched on to cover the particular area. A soft switch occurs when, for a period of time, the first cell and the second cell overlap. For example, before the first cell is switched off for the particular area, the second cell may be switched on for the particular area, and the first cell and the second cell may provide overlapping coverage for the particular area. A hard switch occurs when the first cell is switched off before the second cell is switched on. In this case, there is some period of time during which the particular area does not have coverage from either the first cell or the second cell.

During a switching event, such as a soft switch or a hard switch, UEs in the first cell are to be handed over to the second cell. Handing over many UEs from the first cell to the second cell can cause a signaling overload as each UE performs a mobility operation (e.g., a handover) to switch cells. Some aspects described herein enable inter-satellite mobility for UEs without causing signaling overload. In some examples, the first cell and the second cell may share a common set of parameters, such as a common cell identifier, a common system information block, or a common feeder link. This may obviate a need for a UE to use a handover process. However, the UE may lack configuration information from a synchronization signal block (SSB) associated with the second cell when switching to the second cell. Some aspects described herein enable SSB switching and new SSB acquisition for inter-satellite mobility.

Based at least in part on the UE performing a soft switching or hard switching procedure between different satellite-provided cells, the UE ensures access to network services. Additionally, or alternatively, the UE (and many other UEs) may avoid using a handover procedure, which may result in signaling overload, thereby conserving computing, power, network, and/or communication resources that may have otherwise been consumed transmitting and receiving signaling, experiencing handover failures, and retransmitting and re-receiving the signaling after experiencing the handover failures. For example, based at least in part on performing soft switching or hard switching, the UE and a network node (e.g., a satellite-based network node) may communicate with a reduced error rate, which may conserve computing, power, network, and/or communication resources that may have otherwise been consumed to detect and/or correct communication errors.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

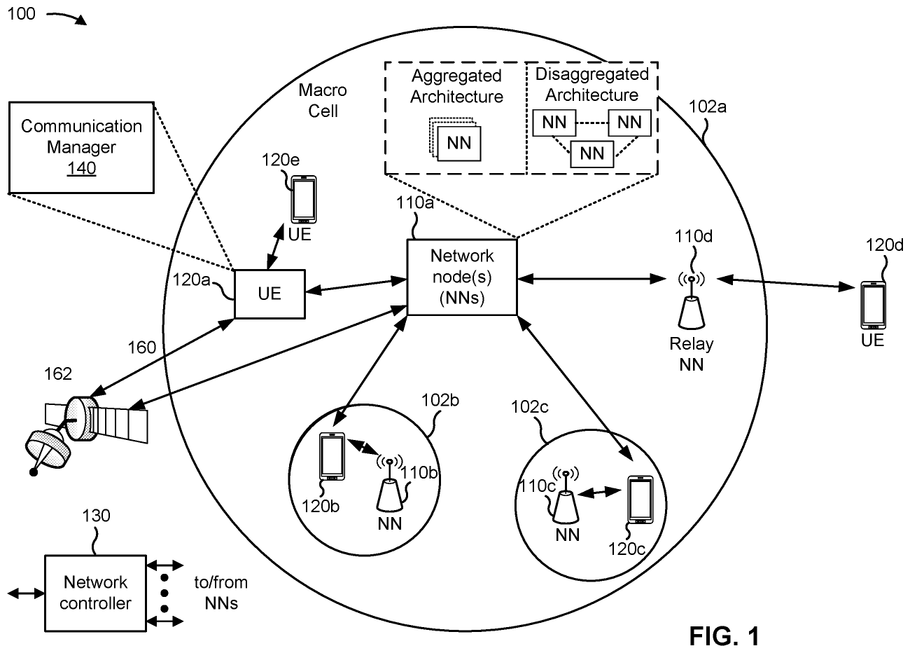

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the wireless network 100 may include one or more non-terrestrial network (NTN) deployments in which a non-terrestrial wireless communication device may include a network node (referred to herein as a “non-terrestrial network node”) and/or a relay station (referred to herein, interchangeably, as a “non-terrestrial relay station”). For example, the wireless network 100 may include an NTNN 162, which may be a non-terrestrial network node or a non-terrestrial relay station. For example, the wireless network 100 may include an NTN 160 provided by an NTNN 162. As used herein, “NTN” may refer to a network for which access is facilitated by a non-terrestrial network node and/or a non-terrestrial relay station (e.g., the NTNN 162).

The wireless network 100 may include any number of NTNNs 162. An NTNN 162 may include a satellite and/or a high-altitude platform (HAP). A HAP may include a balloon, a dirigible, an airplane, and/or an unmanned aerial vehicle. An NTNN 162 may be part of an NTN 160 that is separate from the wireless network 100. Alternatively, an NTN 160 may be part of the wireless network 100. Satellites (e.g., NTNNs 162) may communicate directly and/or indirectly with other entities in wireless network 100 using satellite communication. The other entities may include UEs, other satellites in the one or more NTN deployments, other types of network nodes (e.g., stationary or ground-based network nodes), relay stations, and/or one or more components and/or devices included in a core network of wireless network 100.

In some aspects, the UE 120 may include a communication manager 140. As described in more detail elsewhere herein, the communication manager 140 may receive information identifying a timing and position for a transition from a first synchronization signal block associated with a first cell to a second synchronization signal block associated with a second cell, wherein the first cell and the second cell have a common physical cell index and a common frequency; and tune from the first synchronization signal block to the second synchronization signal block in accordance with the timing and position. Additionally, or alternatively, the communication manager 140 may perform one or more other operations described herein.

As indicated above, FIG. 1 is provided as an example. Other examples may differ from what is described with regard to FIG. 1.

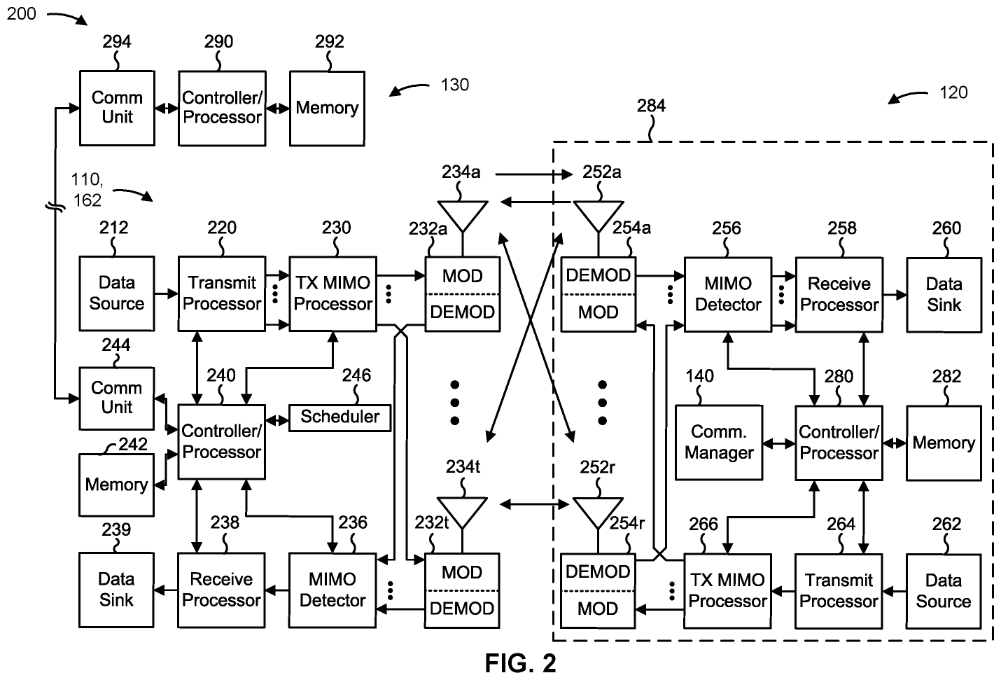

FIG. 2 is a diagram illustrating an example 200 of a network node 110 (or NTNN 162) in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

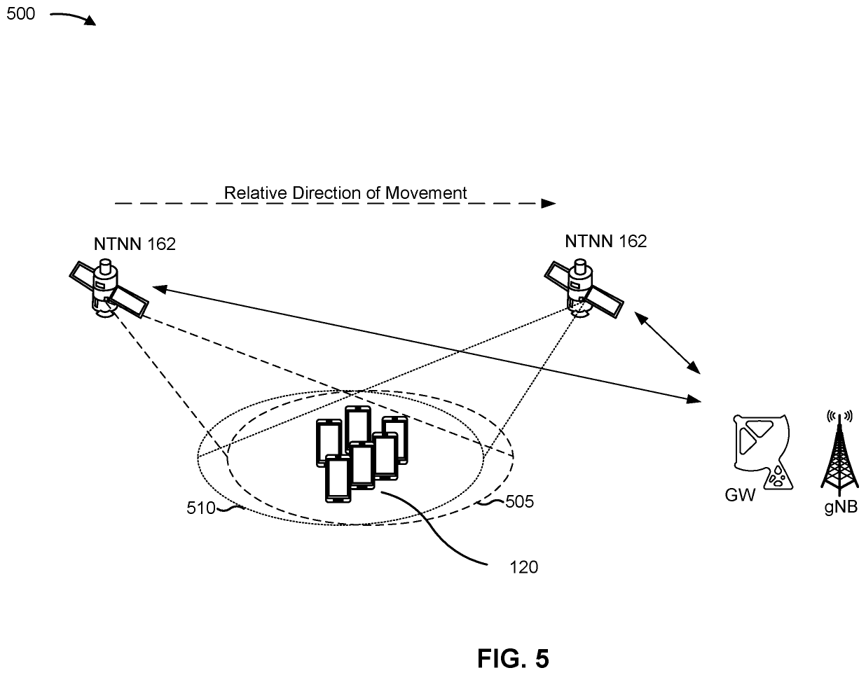

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-8).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-8).

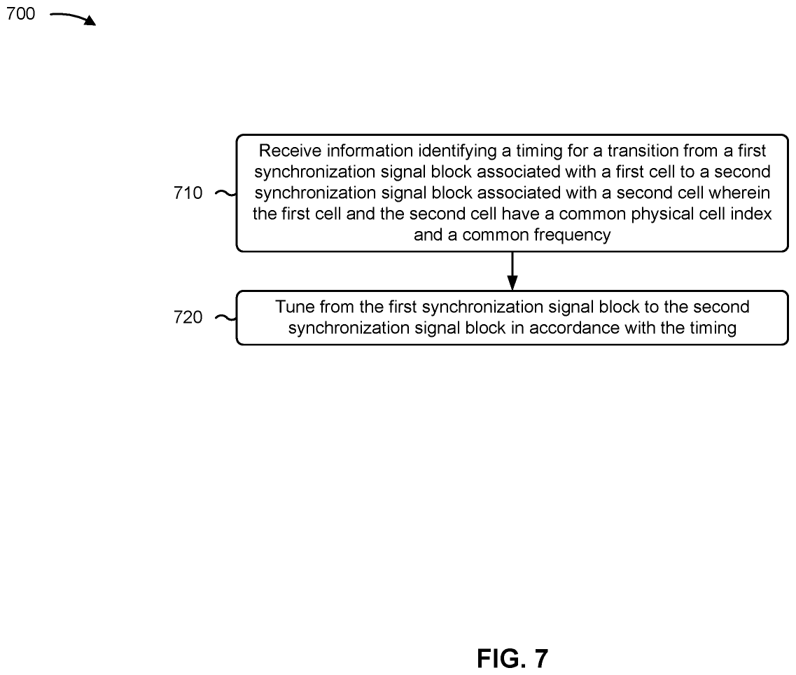

The controller/processor 240 of the network node 110, the controller/processor 280 of the UE 120, and/or any other component(s) of FIG. 2 may perform one or more techniques associated with inter-satellite mobility, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7 and/or other processes as described herein. In some examples, executing instructions may include running the instructions, converting the instructions, compiling the instructions, and/or interpreting the instructions, among other examples.

In some aspects, the UE 120 includes means for receiving information identifying a timing and position for a transition from a first synchronization signal block associated with a first cell to a second synchronization signal block associated with a second cell, wherein the first cell and the second cell have a common physical cell index and a common frequency; and/or means for tuning from the first synchronization signal block to the second synchronization signal block in accordance with the timing and position. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

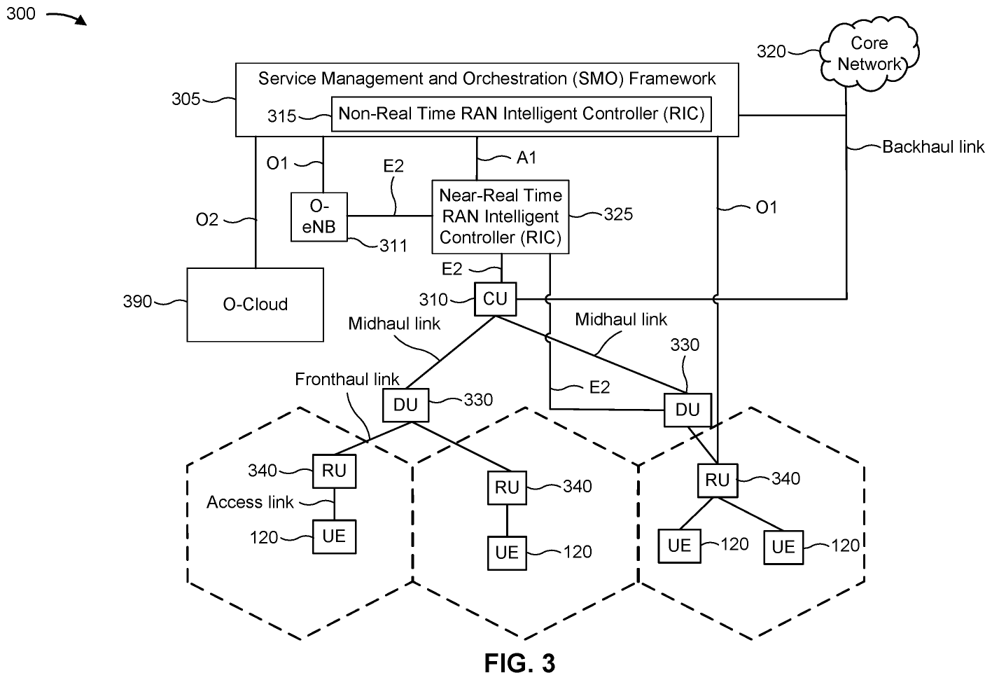

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

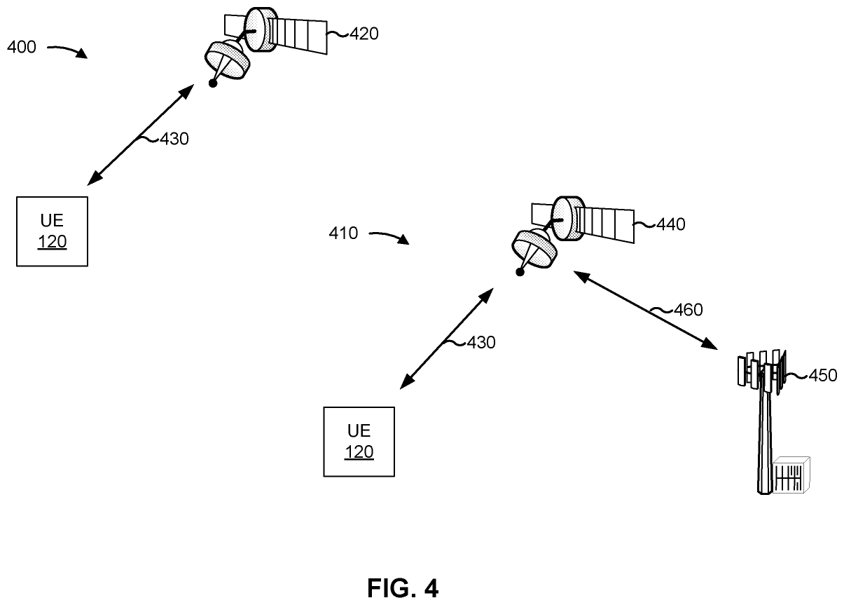

FIG. 4 is a diagram illustrating an example 400 of a regenerative satellite deployment and an example 410 of a transparent satellite deployment in a non-terrestrial network.

Example 400 shows a regenerative satellite deployment. In example 400, a UE 120 is served by a satellite 420 via a service link 430. For example, the satellite 420 may include a network node 110 (e.g., network node 110a) or a gNB. In some aspects, the satellite 420 may be referred to as a non-terrestrial base station, a regenerative repeater, or an on-board processing repeater. In some aspects, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 120.

Example 410 shows a transparent satellite deployment, which may also be referred to as a bent-pipe satellite deployment. In example 410, a UE 120 is served by a satellite 440 via the service link 430. The satellite 440 may be a transparent satellite. The satellite 440 may relay a signal received from gateway 450 via a feeder link 460. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 430 to a frequency of the uplink radio frequency transmission on the feeder link 460, and may amplify and/or filter the uplink radio frequency transmission. In some aspects, the UEs 120 shown in example 400 and example 410 may be associated with a Global Navigation Satellite System (GNSS) capability or a Global Positioning System (GPS) capability, though not all UEs have such capabilities. The satellite 440 may provide a cell that covers the UE 120.

The service link 430 may include a link between the satellite 440 and the UE 120, and may include one or more of an uplink or a downlink. The feeder link 460 may include a link between the satellite 440 and the gateway 450, and may include one or more of an uplink (e.g., from the UE 120 to the gateway 450) or a downlink (e.g., from the gateway 450 to the UE 120). Similarly, an uplink of the feeder link 460 may be indicated by reference number 460-U (not shown in FIG. 4) and a downlink of the feeder link 460 may be indicated by reference number 460-D (not shown in FIG. 4).

The feeder link 460 and the service link 430 may each experience Doppler effects due to the movement of the satellites 420 and 440, and potentially movement of a UE 120. These Doppler effects may be significantly larger than in a terrestrial network. The Doppler effect on the feeder link 460 may be compensated for to some degree, but may still be associated with some amount of uncompensated frequency error. Furthermore, the gateway 450 may be associated with a residual frequency error, and/or the satellite 420/440 may be associated with an on-board frequency error. These sources of frequency error may cause a received downlink frequency at the UE 120 to drift from a target downlink frequency.

As indicated above, FIG. 4 is provided as an example. Other examples may differ from what is described with regard to FIG. 4.

FIG. 5 is a diagram illustrating an example 500 of a handover in a non-terrestrial network.

As shown in FIG. 5, a first NTNN 162 may provide a first cell 505 and a second NTNN 162 may provide a second cell 510. A group of UEs 120 may operate in a coverage area that can be serviced by the first cell 505 and the second cell 510. In other words, the group of UEs 120 are located in an area that, at some times, is serviced by the first cell 505 and that, at other times, may be serviced by the second cell 510. As shown, at one particular time, the first cell 505 and the second cell 510 may overlap, such that the group of UEs 120 are in a coverage area of both the first cell 505 and the second cell 510.

In a fixed cell scenario, satellite cells remain fixed at a given area for a particular duration. For example, the first NTNN 162 may provide the first cell 505 at an area that includes the group of UEs 120 for a first duration, after which the first cell 505 is switched off. When the first cell 505 is switched off, the second cell 510, provided by the second NTNN 162, may be switched on to provide coverage for the group of UEs 120. In a soft switching scenario, the second cell 510 is switched on before the first cell 505 is switched off, thereby providing a period of overlapping coverage. In a hard switching scenario, the second cell 510 is switched on after the first cell 505 is switched off, which results in a period without any coverage (from the first NTNN 162 or the second NTNN 162).

When a switch occurs, such as a soft switch or a hard switch, the group of UEs 120 are handed over between NTNNs 162. For example, the group of UEs 120 are handed over from the first NTNN 162 to the second NTNN 162. The period of time during which an area is covered by beams from both the first NTNN 162 and the second NTNN 162 can be relatively short, such as less than 10 seconds (s), based at least in part on a beam footprint size and a satellite constellation configuration. As a result, the period in which each UE 120 of the group of UEs 120 completes a handover between the first NTNN 162 and the second NTNN 162 is relatively short. A handover procedure may include a plurality of exchanged messages between a UE 120 and both the first NTNN 162 and the second NTNN 162. Further, the first NTNN 162 and the second NTNN 162 may communicate with each other (directly or indirectly) and/or with one or more core network nodes to complete a handover of a UE 120. Accordingly, when many UEs 120 are performing handovers in a relatively short period of time, a network may experience a signaling overload. This may result in some signaling being dropped, which may cause some handover procedures to fail. When a handover procedure fails, a UE 120 may retry the handover or may attempt to obtain initial access again, which results in even more signaling, as well as usage of processing and power resources. Further, when a handover procedure fails, a UE 120 may experience a communication interruption.

As indicated above, FIG. 5 is provided as an example. Other examples may differ from what is described with regard to FIG. 5.

Some aspects described herein enable inter-satellite mobility for UEs without causing signaling overload. For example, when a first NTN cell and a second NTN cell share a common set of parameters, such as a cell identifier, a system information block (SIB), or a feeder link, among other examples, a UE may switch from the first NTN cell to the second NTN cell using the common set of parameters. In this way, the UE avoids performing a handover, thereby reducing a signaling load on a network. By reducing a signaling load on the network, the UE reduces a likelihood of dropped signaling messages, thereby reducing network congestion, delays in providing network services, and/or a likelihood of communication interruption.

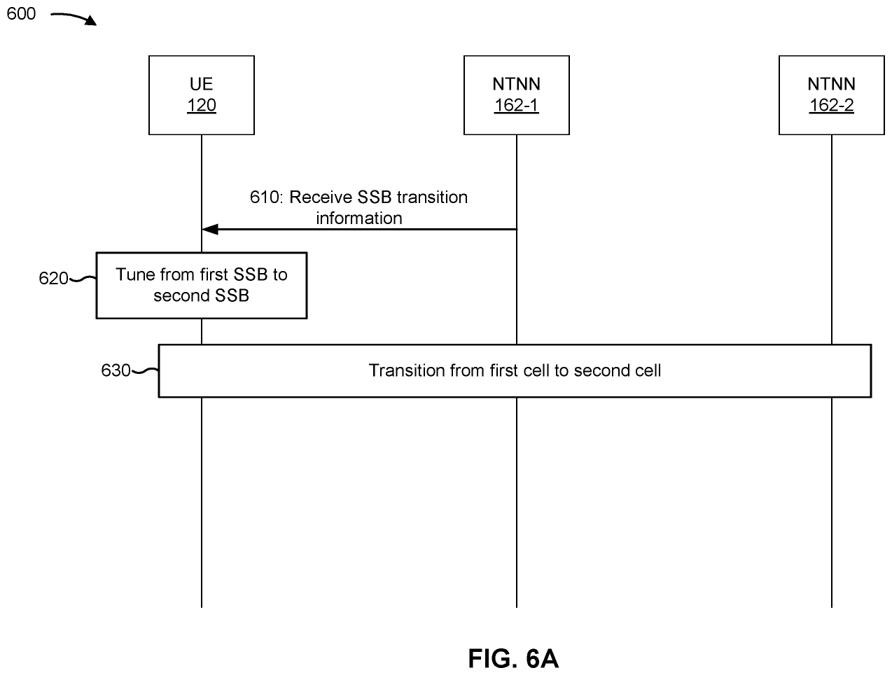

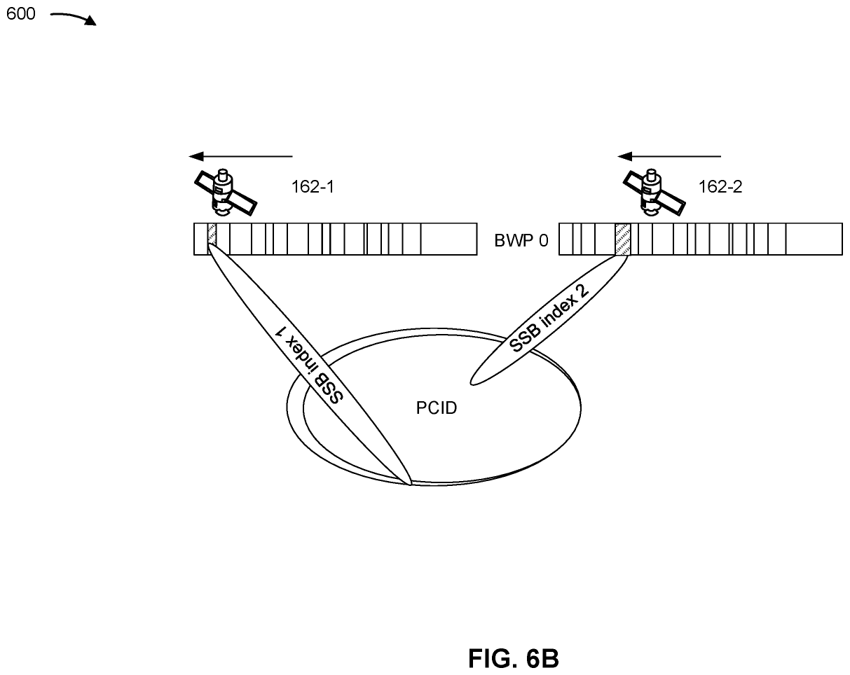

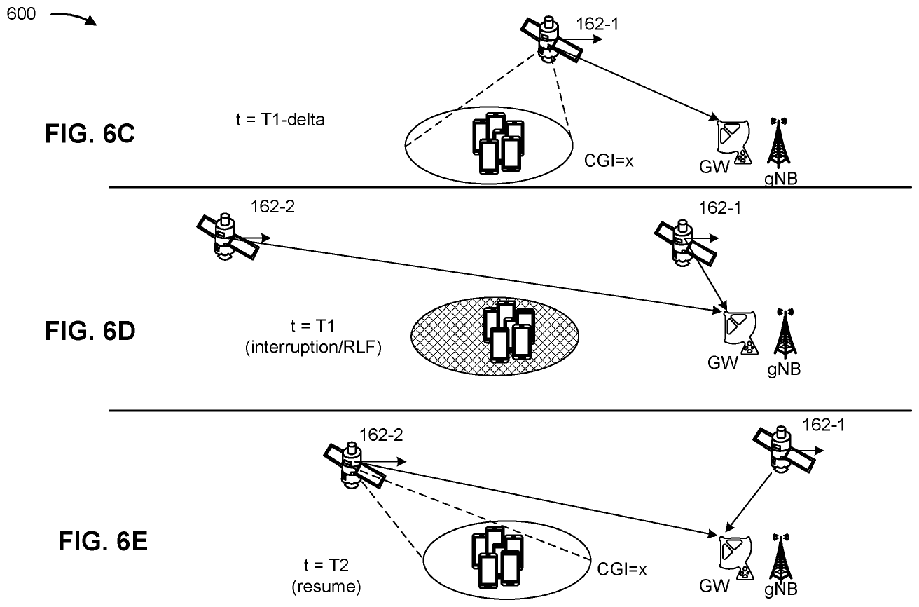

FIGS. 6A-6E are diagrams illustrating an example 600 of inter-satellite mobility. As shown in FIG. 6A, example 600 includes a UE 120 and a set of NTNNs 162-1 and 162-2.

As further shown in FIG. 6A, and by reference number 610, the UE 120 may receive SSB transition information. For example, the UE 120 may receive information identifying a timing and a position for transitioning from a first SSB associated with a first cell of NTNN 162-1 to a second SSB associated with a second cell of NTNN 162-2. In this case, the timing information may include information indicating an SSB end time for the first SSB and an SSB start time for the second SSB.

In some aspects, the UE 120 may receive SSB transition information, for a hard SSB switch, that includes ephemeris data. Ephemeris data may include, for NTNN 162-1 and/or NTNN 162-2, information identifying a current location, a predicted location at a future time, a timing, or a status. For example, the UE 120 may receive, from NTNN 162-1, new ephemeris data valid at a switching time t_{switch}, which corresponds to a time at which the UE 120 is to switch from the NTNN 162-1 to the NTNN 162-2 and which may be broadcast to the UE 120 and/or other UEs 120. In this case, when the UE 120 is to perform a hard SSB switch, the NTNN 162-1 and the NTNN 162-2 may synchronize an SSB timing (e.g., by pre-compensating the SSB timing) to ensure timing consistency, after the switching time, to a threshold degree.

In some aspects, the UE 120 may receive SSB transition information, for a soft SSB switch, that includes ephemeris data. For example, a first SSB (e.g., SSB1) of NTNN 162-1 and a second SSB (e.g., SSBx, such as an SSB2, SSB3, or SSB4) of NTNN 162-2 may have different ephemeris data and a common timing advance (TA) value. As shown in FIG. 6B, the NTNN 162-1 may have a first SSB index 1 (SSB1) that is transmitted at a first time resource within a slot and the NTNN 162-2 may have a second SSB index 2 (SSB2) at a second time resource within the slot. In this case, the NTNN 162-1 and the NTNN 162-2 may provide respective cells with a common physical cell identifier (PCID) and may use a common bandwidth part (BWPO) for transmission.

In this case, the UE 120 may receive, in a SIB (e.g., a SIB19) broadcast in a serving cell (e.g., of NTNN 162-1), information identifying ephemeris data for SSBx and identifying an association between SSBx and NTNN 162-2. Additionally, or alternatively, the UE 120 may receive dedicated (e.g., unicast) signaling identifying the ephemeris data for SSBx and/or the association between SSBx and NTNN 162-2. In some aspects, the NTNN 162-1 may transmit the SSB transition information to the UE 120 using time division multiplexing (TDM). For example, the NTNN 162-1 may use TDM to transmit a SIB19 associated with SSB1 and a SIB19 associated with SSBx.

In some aspects, the UE 120 may receive, for a soft SSB switch, SSB transition information identifying SSBs in different time positions. For example, the UE 120 may have acquired a first SSB (e.g., SSB1) from the NTNN 162-1, and may receive configuration information indicating that the NTNN 162-2 is transmitting a second SSB (e.g., SSBx) that does not overlap with the first SSB. In this case, the UE 120 may receive SSB transition information indicating an end time for SSB1, which may correspond to a cell stop time being broadcast to the UE 120 in a SIB message. Similarly, the UE 120 may receive, in a broadcast SIB message, information indicating a start time of the SSBx, which may correspond to a time occurring before the cell stop time. Additionally, or alternatively, the UE 120 may receive information indicating a position of SSBx via a SIB message or a radio resource control (RRC) message. In some aspects, as described above with regard to the SSB hard switch, the NTNNs 162 may pre-compensate SSB timing to ensure timing consistency to a threshold level for a soft SSB switch. In this case, an SSB1 and SSBx arrival time may be approximately the same (e.g., a time gap of less than a threshold from a first SSB stop time to a second SSB start time).

In some aspects, the UE 120 may be updated with a start time for a second SSB. For example, the UE 120 may be updated with information identifying the start time for the second SSB. In this case, the UE 120 may start a cell search procedure at the indicated start time. Alternatively, the UE 120 may start the cell search procedure when a handover command is received. For example, the first cell or the second cell may convey a handover command (e.g., the NTNN 162-1 or 162-2 may execute the handover command) at the indicated start time and the UE 120 may start the cell search procedure based at least in part on receiving the handover command. This may enable compatibility for existing UEs, legacy UEs, or older versions of UEs (e.g., 3GPP Release 17 UEs).

As further shown in FIG. 6A, and by reference numbers 620 and 630, the UE 120 may tune from a first SSB to a second SSB and transition from a first cell to a second cell. For example, the UE 120 may transition from receiving communication services from NTNN 162-1 to receiving communication services from NTNN 162-2.

As shown in FIG. 6C, the UE 120 (and other UEs 120) are connected to NTNN 162-1 at a first time t=T1-delta, where NTNN 162-1 is a source satellite. As shown in FIG. 6D, at a second time, t=T1, which may correspond to the switching time, the UE 120 experiences an interruption or radio link failure. As shown in FIG. 6E, at a third time, t=T2, which may correspond to a period of time after the interruption or radio link failure, the UE 120 regains access to a cell provided by the NTNN 162-2, which is a new source satellite for the UE 120. In this case, the cell global identity (CGI) remains the same between the first cell provided by NTNN 162-1 and the second cell provided by NTNN 162-2.

In some aspects, the UE 120 may perform a hard SSB switch to transition from NTNN 162-1 to NTNN 162-2. As described above, in a hard SSB switch, the UE 120 may receive ephemeris data and information identifying a switching time t_{switch}, and the NTNNs 162 may pre-compensate the SSB timing to maintain a threshold degree of consistency between a first timing of the first SSB and a second timing of the second SSB. As a result, the UE 120 may re-acquire the SSB timing after the switching time. For example, the UE 120 may refrain from uplink transmission after the switching time until at least a re-acquisition time t_{switch}+T1. Similarly, the UE 120 may start monitoring for a physical downlink control channel (PDCCH) at a monitoring time t_{switch}+T2. In some aspects, the UE 120 may reset one or more parameters when performing a hard SSB switch and transitioning between the NTNNs 162. For example, the UE 120 may reset a timing advance (TA) command accumulation to a default value (e.g., 0) and/or reset a Koffset parameter to a new system Koffset parameter for NTNN 162-2. Additionally, or alternatively, the UE 120 may reset a layer 1 filtering parameter or a layer 3 filtering parameter for a service cell (e.g., of NTNN 162-2) based at least in part on transitioning between NTNNs 162. Resetting layer 3 filtering may include the UE 120 resetting a layer 3 measurement window from a satellite switch time to a new satellite to a second SSB start time. Similarly, resetting layer 1 filtering may include restarting a timer (e.g., timer T310 and/or timer T311) and/or resetting a counter (e.g., counter N310 and/or counter N311).

After the re-acquisition time, the UE 120 may transmit an uplink communication to the NTNN 162-2 as an initial transmission (e.g., with an associated timing requirement for initial transmissions) and may initiate a random access channel (RACH) procedure to acquire service on the NTNN 162-2. In another example of a hard SSB switch, the UE 120 may expire a synchronization timer at the switching time. For example, the UE 120 may be configured to treat the switching time as a cell stop time and may determine that an uplink synchronization timer is expired when the switching time occurs. In this case, the UE 120 may stop uplink transmission and attempt to acquire a SIB, such as SIB19.

In some aspects, the UE 120 may perform a soft SSB switch to transition from the NTNN 162-1 to the NTNN 162-2. For example, as described above, the UE 120 may search for an SSBx of the NTNN 162-2 before a cell stop time and acquire the SSBx before an end time of an SSB1 of the NTNN 162-1. Additionally, or alternatively, when the NTNNs 162 have pre-compensated the SSB timing, the respective SSB1 and SSBx arrival times are synchronized. Accordingly, the UE 120 may re-acquire SSBx after an SSB1 end time. For a soft SSB switch, the UE 120 may use time division multiplexing (TDM) to receive different SIBs with different control resource sets (CORESETs). For example, the UE 120 may receive SIB1 (scheduling SIB19) and SIB19 messages using TDM.

In some aspects, the UE 120 may trigger a RACH procedure in connection with performing a soft SSB switch. For example, when the UE 120 detects SSBx and reads a SIB associated with SSBx, the UE 120 may trigger a RACH procedure to synchronize with the NTNN 162-2 and/or to indicate, to the NTNN 162-2, that the UE 120 has switched to the SSBx. Additionally, or alternatively, the UE 120 may trigger a radio link failure (RLF) or an RRC re-establishment procedure based at least in part on detecting the SSBx.

In some aspects, the UE 120 may perform a RACH-less synchronization. For example, when a first TA value of NTNN 162-1 is within a threshold amount of a second TA value of the NTNN 162-2, the UE 120 may reset the TA and apply a new TA pre-compensation to transmit on an uplink (e.g., without having performed a RACH procedure). Additionally, or alternatively, the UE 120 may refrain from resetting the TA value before uplink transmission, and may, instead, adjust a TA of the UE 120 based at least in part on a position of the UE 120 and a position of the NTNN 162-2. In some aspects, the UE 120 may trigger a TA report to update the NTNN 162-2 with a new TA that the UE 120 is using. For example, based at least in part on detecting the SSBx, the UE 120 may trigger the TA report, thereby enabling the NTNN 162-2 to determine a timing of the UE 120. Additionally, or alternatively, based at least in part on detecting the SSBx, the UE 120 may invalidate a UE-specific Koffset parameter of the NTNN 162-1 and may use a cell-specific Koffset parameter of the NTNN 162-2 or a new UE-specific Koffset parameter signaled by the NTNN 162-2.

In some aspects, the UE 120 may communicate on a cell provided by the NTNN 162-2. For example, based at least in part on synchronizing with the NTNN 162-2, the UE 120 may receive data from and/or transmit data to the NTNN 162-2, which may enable the UE 120 to obtain network services within the cell provided by the NTNN 162-2. In this way, the UE 120 can switch from NTNN 162-1 to NTNN 162-1 without performing a handover procedure, which reduces a likelihood of a signaling overload associated with many UEs performing concurrent handovers between NTNNs.

As indicated above, FIGS. 6A-6E are provided as examples. Other examples may differ from what is described with regard to FIGS. 6A-6E.

FIG. 7 is a diagram illustrating an example process 700 performed, for example, by a UE, in accordance with the present disclosure. Example process 700 is an example where the UE (e.g., UE 120) performs operations associated with inter-satellite mobility.

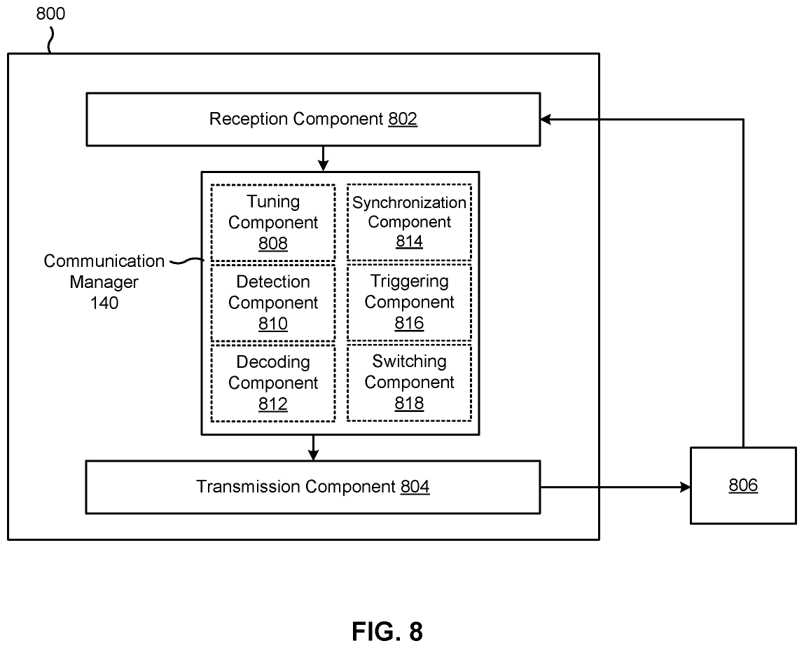

As shown in FIG. 7, in some aspects, process 700 may include receiving information identifying a timing and position for a transition from a first synchronization signal block associated with a first cell to a second synchronization signal block associated with a second cell, wherein the first cell and the second cell have a common physical cell index and a common frequency (block 710). For example, the UE (e.g., using communication manager 140 and/or reception component 802, depicted in FIG. 8) may receive information identifying a timing and position for a transition from a first synchronization signal block associated with a first cell to a second synchronization signal block associated with a second cell, wherein the first cell and the second cell have a common physical cell index and a common frequency, as described above. In some aspects, the first cell and the second cell have a common physical cell index and a common frequency.

As further shown in FIG. 7, in some aspects, process 700 may include tuning from the first synchronization signal block to the second synchronization signal block in accordance with the timing and position (block 720). For example, the UE (e.g., using communication manager 140 and/or tuning component 808, depicted in FIG. 8) may tune from the first synchronization signal block to the second synchronization signal block in accordance with the timing and position, as described above.

Process 700 may include additional aspects, such as any single aspect or any combination of aspects described below and/or in connection with one or more other processes described elsewhere herein.

In a first aspect, the first synchronization signal block is transmitted in a first timing position and the second synchronization signal block is transmitted in a second timing position that does not overlap with the first timing position.

In a second aspect, alone or in combination with the first aspect, the second synchronization signal block is a plurality of synchronization signal blocks.

In a third aspect, alone or in combination with one or more of the first and second aspects, the timing is associated with at least one of an end time for the first synchronization signal block, a cell stop time broadcast in a serving cell system information block, a start time for the second synchronization signal block, a search time for the second synchronization signal block, or a position for the second synchronization signal block.

In a fourth aspect, alone or in combination with one or more of the first through third aspects, the first synchronization signal block and the second synchronization signal block have respective arrival times within a threshold range, and process 700 includes reacquiring the second synchronization signal block based at least in part on the first synchronization signal block and the second synchronization signal block having respective arrival times within a threshold range.

In a fifth aspect, alone or in combination with one or more of the first through fourth aspects, respective control resource sets and system information blocks of the first synchronization signal block and the second synchronization signal block are time division multiplexed with different downlink timings.

In a sixth aspect, alone or in combination with one or more of the first through fifth aspects, the first synchronization signal block and the second synchronization signal block have a common timing advance value and different ephemeris data.

In a seventh aspect, alone or in combination with one or more of the first through sixth aspects, process 700 includes receiving, via broadcast signaling or dedicated signaling, a system information block identifying configuration information for the second synchronization signal block, wherein the system information block identifying configuration information for the second synchronization signal block is time division multiplexed with another system information block associated with the first synchronization signal block.

In an eighth aspect, alone or in combination with one or more of the first through seventh aspects, process 700 includes detecting the second synchronization signal block based at least in part on tuning from the first synchronization signal block to the second synchronization signal block, decoding one or more system information blocks associated with the second synchronization signal block, and synchronizing with the second cell based at least in part on information included in the one or more system information blocks.

In a ninth aspect, alone or in combination with one or more of the first through eighth aspects, process 700 includes triggering a random access channel procedure to synchronize with the second cell based at least in part on tuning from the first synchronization signal block to the second synchronization signal block.

In a tenth aspect, alone or in combination with one or more of the first through ninth aspects, process 700 includes synchronizing, based at least in part on tuning from the first synchronization signal block to the second synchronization signal block, with the second cell using a timing advance associated with the second cell.

In an eleventh aspect, alone or in combination with one or more of the first through tenth aspects, process 700 includes detecting the second synchronization signal block based at least in part on tuning from the first synchronization signal block to the second synchronization signal block, and switching from a UE-specific offset value to a cell-specific offset value based at least in part on detecting the second synchronization signal block.

In a twelfth aspect, alone or in combination with one or more of the first through eleventh aspects, process 700 includes detecting the second synchronization signal block based at least in part on tuning from the first synchronization signal block to the second synchronization signal block, and triggering a timing advance report based at least in part on detecting the second synchronization signal block.

In a thirteenth aspect, alone or in combination with one or more of the first through twelfth aspects, process 700 includes receiving ephemeris data associated with the second cell, and tuning to the second synchronization signal block comprises tuning to the second synchronization signal block based at least in part on the ephemeris data.

In a fourteenth aspect, alone or in combination with one or more of the first through thirteenth aspects, a timing consistency criterion is satisfied by the first synchronization signal block and the second synchronization signal block, and process 700 includes acquiring a synchronization signal block timing after a switching time associated with the ephemeris data.

In a fifteenth aspect, alone or in combination with one or more of the first through fourteenth aspects, process 700 includes communicating on the second cell after a threshold period of time has elapsed from tuning to the second synchronization signal block, wherein the threshold period of time is based at least in part on at least one of an identified switching time or a re-acquisition time.

In a sixteenth aspect, alone or in combination with one or more of the first through fifteenth aspects, a timing advance command or a system offset value is reset based at least in part on tuning from the first synchronization signal block to the second synchronization signal block.

In a seventeenth aspect, alone or in combination with one or more of the first through sixteenth aspects, process 700 includes determining that a trigger condition for expiration of an uplink synchronization timer is satisfied, and acquiring a system information block to identify new synchronization information based at least in part on determining that the trigger condition is satisfied.

In an eighteenth aspect, alone or in combination with one or more of the first through seventeenth aspects, the first cell is associated with a first satellite and the second cell is associated with a second satellite.

In a nineteenth aspect, alone or in combination with one or more of the first through eighteenth aspects, process 700 includes resetting at least one of layer 1 filtering or layer 3 filtering for the serving cell based at least in part on tuning to the second synchronization signal block.

In a twentieth aspect, alone or in combination with one or more of the first through nineteenth aspects, process 700 includes triggering at least one of a layer 1 measurement report or a layer 3 measurement report based at least in part on tuning to the second synchronization signal block.

In a twenty-first aspect, alone or in combination with one or more of the first through twentieth aspects, process 700 includes updating the UE with information identifying a start time for a second synchronization signal block; and starting a cell search at the start time or when a handover command is received, the handover command being executed at the start time.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE, or a UE may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include the communication manager 140. The communication manager 140 may include one or more of a tuning component 808, a detection component 810, a decoding component 812, a synchronization component 814, a triggering component 816, or a switching component 818, among other examples.

In some aspects, the apparatus 800 may be configured to perform one or more operations described herein, such as operations described with regard to FIGS. 6A-6E. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The reception component 802 may receive information identifying a timing and position for a transition from a first synchronization signal block associated with a first cell to a second synchronization signal block associated with a second cell, wherein the first cell and the second cell have a common physical cell index and a common frequency. The tuning component 808 may tune from the first synchronization signal block to the second synchronization signal block in accordance with the timing and position.

The reception component 802 may receive, via broadcast signaling or dedicated signaling, a system information block identifying configuration information for the second synchronization signal block, wherein the system information block identifying configuration information for the second synchronization signal block is time division multiplexed with another system information block associated with the first synchronization signal block.

The detection component 810 may detect the second synchronization signal block based at least in part on tuning from the first synchronization signal block to the second synchronization signal block. The decoding component 812 may decode one or more system information blocks associated with the second synchronization signal block. The synchronization component 814 may synchronize with the second cell based at least in part on information included in the one or more system information blocks. The triggering component 816 may trigger a random access channel procedure to synchronize with the second cell based at least in part on tuning from the first synchronization signal block to the second synchronization signal block.

The synchronization component 814 may synchronize, based at least in part on tuning from the first synchronization signal block to the second synchronization signal block, with the second cell using a timing advance associated with the second cell. The detection component 810 may detect the second synchronization signal block based at least in part on tuning from the first synchronization signal block to the second synchronization signal block. The switching component 818 may switch from a UE-specific offset value to a cell-specific offset value based at least in part on detecting the second synchronization signal block.

The detection component 810 may detect the second synchronization signal block based at least in part on tuning from the first synchronization signal block to the second synchronization signal block. The triggering component 816 may trigger a timing advance report based at least in part on detecting the second synchronization signal block. The reception component 802 may receive ephemeris data associated with the second cell. The reception component 802 and/or the transmission component 804 may communicate on the second cell after a threshold period of time has elapsed from tuning to the second synchronization signal block, wherein the threshold period of time is based at least in part on at least one of an identified switching time or a re-acquisition time. The triggering component 816 may determine that a trigger condition for expiration of an uplink synchronization timer is satisfied. The synchronization component 814 may acquire a system information block to identify new synchronization information based at least in part on determining that the trigger condition is satisfied.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by an apparatus of a user equipment (UE), comprising: receiving information identifying a timing and position for a transition from a first synchronization signal block associated with a first cell to a second synchronization signal block associated with a second cell, wherein the first cell and the second cell have a common physical cell index and a common frequency; and tuning from the first synchronization signal block to the second synchronization signal block in accordance with the timing and position.

Aspect 2: The method of Aspect 1, wherein the first synchronization signal block is transmitted in a first timing position and the second synchronization signal block is transmitted in a second timing position that does not overlap with the first timing position.

Aspect 3: The method of any of Aspects 1 to 2, wherein the second synchronization signal block is a plurality of synchronization signal blocks.

Aspect 4: The method of any of Aspects 1 to 3, wherein the timing is associated with at least one of: an end time for the first synchronization signal block, a cell stop time broadcast in a serving cell system information block, a start time for the second synchronization signal block, a search time for the second synchronization signal block, or a position for the second synchronization signal block.

Aspect 5: The method of any of Aspects 1 to 4, wherein the first synchronization signal block and the second synchronization signal block have respective arrival times within a threshold range, and wherein tuning from the first synchronization signal block to the second synchronization signal block comprises: reacquiring the second synchronization signal block based at least in part on the first synchronization signal block and the second synchronization signal block having respective arrival times within a threshold range.

Aspect 6: The method of any of Aspects 1 to 5, wherein respective control resource sets and system information blocks of the first synchronization signal block and the second synchronization signal block are time division multiplexed with different downlink timings.

Aspect 7: The method of any of Aspects 1 to 6, wherein the first synchronization signal block and the second synchronization signal block have a common timing advance value and different ephemeris data.

Aspect 8: The method of any of Aspects 1 to 7, further comprising: receiving, via broadcast signaling or dedicated signaling, a system information block identifying configuration information for the second synchronization signal block, wherein the system information block identifying configuration information for the second synchronization signal block is time division multiplexed with another system information block associated with the first synchronization signal block.

Aspect 9: The method of any of Aspects 1 to 8, further comprising: detecting the second synchronization signal block based at least in part on tuning from the first synchronization signal block to the second synchronization signal block; decoding one or more system information blocks associated with the second synchronization signal block; and synchronizing with the second cell based at least in part on information included in the one or more system information blocks.

Aspect 10: The method of any of Aspects 1 to 9, further comprising: triggering a random access channel procedure to synchronize with the second cell based at least in part on tuning from the first synchronization signal block to the second synchronization signal block.

Aspect 11: The method of any of Aspects 1 to 10, further comprising: synchronizing, based at least in part on tuning from the first synchronization signal block to the second synchronization signal block, with the second cell using a timing advance associated with the second cell.

Aspect 12: The method of any of Aspects 1 to 11, further comprising: detecting the second synchronization signal block based at least in part on tuning from the first synchronization signal block to the second synchronization signal block; and switching from a UE-specific offset value to a cell-specific offset value based at least in part on detecting the second synchronization signal block.

Aspect 13: The method of any of Aspects 1 to 12, further comprising: detecting the second synchronization signal block based at least in part on tuning from the first synchronization signal block to the second synchronization signal block; and triggering a timing advance report based at least in part on detecting the second synchronization signal block.

Aspect 14: The method of any of Aspects 1 to 13, further comprising: receiving ephemeris data associated with the second cell; and wherein tuning from the first synchronization signal block to the second synchronization signal block comprises tuning to the second synchronization signal block based at least in part on the ephemeris data.

Aspect 15: The method of Aspect 14, wherein a timing consistency criterion is satisfied by the first synchronization signal block and the second synchronization signal block, and further comprising: re-acquiring a synchronization signal block timing after a switching time associated with the ephemeris data.

Aspect 16: The method of any of Aspects 1 to 15, further comprising: communicating on the second cell after a threshold period of time has elapsed from tuning to the second synchronization signal block, wherein the threshold period of time is based at least in part on at least one of an identified switching time or a re-acquisition time.

Aspect 17: The method of any of Aspects 1 to 16, wherein a timing advance command or a system offset value is reset based at least in part on tuning from the first synchronization signal block to the second synchronization signal block.

Aspect 18: The method of any of Aspects 1 to 17, further comprising: determining that a trigger condition for expiration of an uplink synchronization timer is satisfied; and acquiring a system information block to identify new synchronization information based at least in part on determining that the trigger condition is satisfied.

Aspect 19: The method of any of Aspects 1 to 18, wherein the first cell is associated with a first satellite and the second cell is associated with a second satellite.

Aspect 20: The method of any of Aspects 1 to 19, further comprising: resetting at least one of layer 1 filtering or layer 3 filtering for the serving cell based at least in part on tuning to the second synchronization signal block.

Aspect 21: The method of any of Aspects 1 to 20, further comprising: updating the UE with information identifying a start time for a second synchronization signal block; and starting a cell search at the start time or when a handover command is received, the handover command being executed at the start time.

Aspect 22: The method of any of Aspects 1 to 21, wherein resetting layer 3 filtering includes resetting a layer 3 measurement window from a satellite switch time to a new satellite to a second SSB start time; and wherein resetting layer 1 filtering includes restarting a timer T310 or a timer T311 or includes resetting a counter N310 or N311.

Aspect 23: The method of any of Aspects 1 to 22, further comprising: triggering at least one of a layer 1 measurement report or a layer 3 measurement report based at least in part on tuning to the second synchronization signal block.

Aspect 24: An apparatus for wireless communication at a device, comprising a processor; memory coupled with the processor; and instructions stored in the memory and executable by the processor to cause the apparatus to perform the method of one or more of Aspects 1-23.

Aspect 25: A device for wireless communication, comprising a memory and one or more processors coupled to the memory, the one or more processors configured to perform the method of one or more of Aspects 1-23.

Aspect 26: An apparatus for wireless communication, comprising at least one means for performing the method of one or more of Aspects 1-23.

Aspect 27: A non-transitory computer-readable medium storing code for wireless communication, the code comprising instructions executable by a processor to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive information identifying a timing and position for a transition from a first synchronization signal block associated with a first cell to a second synchronization signal block associated with a second cell,
wherein the first cell and the second cell have a common physical cell index and a common frequency; and
tune from the first synchronization signal block to the second synchronization signal block in accordance with the timing and position.

2. The UE of claim 1, wherein the first synchronization signal block is transmitted in a first timing position and the second synchronization signal block is transmitted in a second timing position that does not overlap with the first timing position.

3. The UE of claim 1, wherein the second synchronization signal block is a plurality of synchronization signal blocks.

4. The UE of claim 1, wherein the timing is associated with at least one of:
an end time for the first synchronization signal block,
a cell stop time broadcast in a serving cell system information block,
a start time for the second synchronization signal block,
a search time for the second synchronization signal block, or
a position for the second synchronization signal block.

5. The UE of claim 1, wherein the first synchronization signal block and the second synchronization signal block have respective arrival times within a threshold range, and
wherein the one or more processors, that cause the UE to tune from the first synchronization signal block to the second synchronization signal block, are configured to cause the UE to:
reacquire the second synchronization signal block based at least in part on the first synchronization signal block and the second synchronization signal block having respective arrival times within a threshold range.

6. The UE of claim 1, wherein respective control resource sets and system information blocks of the first synchronization signal block and the second synchronization signal block are time division multiplexed with different downlink timings.

7. The UE of claim 1, wherein the first synchronization signal block and the second synchronization signal block have a common timing advance value and different ephemeris data.

8. The UE of claim 1, wherein the one or more processors are further configured to:
receive, via broadcast signaling or dedicated signaling, a system information block identifying configuration information for the second synchronization signal block,
wherein the system information block identifying configuration information for the second synchronization signal block is time division multiplexed with another system information block associated with the first synchronization signal block.

9. The UE of claim 1, wherein the one or more processors are further configured to:
detect the second synchronization signal block based at least in part on tuning from the first synchronization signal block to the second synchronization signal block;
decode one or more system information blocks associated with the second synchronization signal block; and
synchronize with the second cell based at least in part on information included in the one or more system information blocks.

10. The UE of claim 1, wherein the one or more processors are further configured to:
trigger a random access channel procedure to synchronize with the second cell based at least in part on tuning from the first synchronization signal block to the second synchronization signal block.

11. The UE of claim 1, wherein the one or more processors are further configured to:
synchronize, based at least in part on tuning from the first synchronization signal block to the second synchronization signal block, with the second cell using a timing advance associated with the second cell.

12. The UE of claim 1, wherein the one or more processors are further configured to:
detect the second synchronization signal block based at least in part on tuning from the first synchronization signal block to the second synchronization signal block; and
switch from a UE-specific offset value to a cell-specific offset value based at least in part on detecting the second synchronization signal block.

13. The UE of claim 1, wherein the one or more processors are further configured to:
detect the second synchronization signal block based at least in part on tuning from the first synchronization signal block to the second synchronization signal block; and
trigger a timing advance report based at least in part on detecting the second synchronization signal block.

14. The UE of claim 1, wherein the one or more processors are further configured to:
receive ephemeris data associated with the second cell; and
wherein the one or more processors, when configured to cause the UE to tune from the first synchronization signal block to the second synchronization signal block, are configured to cause the UE to:
tune to the second synchronization signal block based at least in part on the ephemeris data.

15. The UE of claim 14, wherein a timing consistency criterion is satisfied by the first synchronization signal block and the second synchronization signal block, and
wherein the one or more processors are further configured to:
acquire a synchronization signal block timing after a switching time associated with the ephemeris data.

16. The UE of claim 1, wherein the one or more processors are further configured to:
communicate on the second cell after a threshold period of time has elapsed from tuning to the second synchronization signal block, wherein the threshold period of time is based at least in part on at least one of an identified switching time or a re-acquisition time.

17. The UE of claim 1, wherein a timing advance command or a system offset value is reset based at least in part on tuning from the first synchronization signal block to the second synchronization signal block.

18. The UE of claim 1, wherein the one or more processors are further configured to:
determine that a trigger condition for expiration of an uplink synchronization timer is satisfied; and
acquire a system information block to identify new synchronization information based at least in part on determining that the trigger condition is satisfied.

19. The UE of claim 1, wherein the first cell is associated with a first satellite and the second cell is associated with a second satellite.

20. The UE of claim 1, wherein the one or more processors are further configured to:
reset at least one of layer 1 filtering or layer 3 filtering for a serving cell based at least in part on tuning to the second synchronization signal block.

21. The UE of claim 20, wherein the one or more processors, to reset the at least one of the layer 1 filter or the layer 3 filter, are configured to at least one of:
reset a layer 3 measurement window from a satellite switch time to a new satellite to a second synchronization signal block start time,
reset a timer T310,
reset a timer T311,
reset a counter N310, or
reset a counter N311.

22. The UE of claim 1, wherein the one or more processors are further configured to:
trigger at least one of a layer 1 measurement report or a layer 3 measurement report based at least in part on tuning to the second synchronization signal block.

23. The UE of claim 1, wherein the one or more processors are further configured to:
update information identifying a start time for the second synchronization signal block; and
start a cell search at the start time or when a handover command is received, the handover command being executed at the start time.

24. A method of wireless communication performed by a user equipment (UE), comprising:
receiving information identifying a timing and position for a transition from a first synchronization signal block associated with a first cell to a second synchronization signal block associated with a second cell,
wherein the first cell and the second cell have a common physical cell index and a common frequency; and
tuning from the first synchronization signal block to the second synchronization signal block in accordance with the timing and position and position.

25. The method of claim 24, wherein the first synchronization signal block is transmitted in a first timing position and the second synchronization signal block is transmitted in a second timing position that does not overlap with the first timing position.

26. The method of claim 24, wherein the second synchronization signal block is a plurality of synchronization signal blocks.

27. The method of claim 24, wherein the timing is associated with at least one of:
an end time for the first synchronization signal block,
a cell stop time broadcast in a serving cell system information block,
a start time for the second synchronization signal block,
a search time for the second synchronization signal block, or
a position for the second synchronization signal block.

28. The method of claim 24, wherein the first synchronization signal block and the second synchronization signal block have respective arrival times within a threshold range, and
further comprising:
reacquiring the second synchronization signal block based at least in part on the first synchronization signal block and the second synchronization signal block having respective arrival times within a threshold range.

29. A non-transitory computer-readable medium storing a set of instructions for wireless communication, the set of instructions comprising:
one or more instructions that, when executed by one or more processors of a user equipment (UE), cause the UE to:
receive information identifying a timing and position for a transition from a first synchronization signal block associated with a first cell to a second synchronization signal block associated with a second cell,
wherein the first cell and the second cell have a common physical cell index and a common frequency; and
tune from the first synchronization signal block to the second synchronization signal block in accordance with the timing and position.

30. An apparatus for wireless communication, comprising:
means for receiving information identifying a timing and position for a transition from a first synchronization signal block associated with a first cell to a second synchronization signal block associated with a second cell,
wherein the first cell and the second cell have a common physical cell index and a common frequency; and
means for tuning from the first synchronization signal block to the second synchronization signal block in accordance with the timing and position and position.
